(19) United States
(12) Patent Application Publication
(10) Pub. No.: US 2026/0061229 A1
(43) Pub. Date: Mar. 5, 2026

(54) POSITIVE PRESSURE RESPIRATOR ASSEMBLY

(71) Applicant: Brandon King, Eagle Mountain, UT (US)

(72) Inventor: Brandon King, Eagle Mountain, UT (US)

(21) Appl. No.: 19/383,569

(22) Filed: Nov. 7, 2025

Related U.S. Application Data
(63) Continuation-in-part of application No. 17/695,785, filed on Mar. 15, 2022.
(60) Provisional application No. 63/161,428, filed on Mar. 15, 2021.
(60) Provisional application No. 63/161,443, filed on Mar. 15, 2021.

(51) Int. Cl. A62B 18/00; A41D 13/002

(52) U.S. Cl. CPC A62B 18/003; A41D 13/0025

(57) ABSTRACT

A positive pressure respirator assembly having a conduit directing exhaust towards the ground is disclosed. The positive pressure respirator assembly may have a conduit that is disposed between a shroud and a user.

### CROSS-REFERENCE TO RELATED APPLICATIONS

The present non-provisional patent application claims the benefit of Non-Provisional U.S. patent application Ser. No. 17/695,785, filed on Mar. 15, 2022. Non-Provisional U.S. patent application Ser. No. 17/695,785 claims the benefit of Provisional U.S. Patent Application Ser. No. 63/161,428 filed on Mar. 15, 2021 and Provisional U.S. Patent Application Ser. No. 63/161,443, which was filed on Mar. 15, 2021; Application Ser. Nos. 17/695,785; 63/161,428; and 63/161,443 are hereby incorporated by reference.

### BACKGROUND OF THE INVENTION

### 1. The Field of the Invention

The present invention relates generally to preserving a sterile or semi-sterile environment; more particularly, the present invention relates to a positive pressure respirator.

### 2. Background

Surgical Site Infections (SSIs) are a major contributor to patient morbidity, cost, and adverse outcomes. Traditional surgical masks do not form a seal, allowing respiratory exhaust to escape toward the operative field. Existing Powered Air-Purifying Respirators (PAPRs) supply purified air to the wearer but allow overflow exhaust to exit uncontrolled around the lower perimeter of the hood. This overflow resembles an ‘overfilled container’, resulting in respiratory exhaust flowing downward along sterile gown surfaces toward the surgical site. A need exists for an improved PAPR assembly.

### SUMMARY

The various implementations of the present invention are provided as a positive pressure assembly, which may include a positive pressure surgical respirator with directed exhaust and acoustic ear seal; this invention relates to positive pressure respirators intended for use in sterile surgical environments. It specifically concerns respirator hoods that intentionally direct respiratory exhaust away from the surgical site, while improving communication and reducing heat load on the wearer.

Some preferred embodiments are as follows:
Embodiment 1: A positive pressure surgical respirator may comprise a hood body, a face shield, an air inlet supplying purified airflow to a respiratory zone defined by the hood body and the face shield, and an exhaust conduit receiving user respiratory exhaust and directing the user respiratory exhaust into the interior side of a surgical gown.
The respirator of Embodiment 1, wherein the airflow may travel downward away from the surgical field.
The respirator of Embodiment 1, which may further comprise an acoustically transparent region sealed by a circumaural ear seal.
The respirator of Embodiment 1, which may further comprise a diffuser located at the exhaust conduit terminus.
The respirator of Embodiment 1, which may further comprise a removable condensation collection reservoir.
The respirator of Embodiment 1, wherein one or more valves may regulate airflow or prevent backflow.
The respirator of Embodiment 1, wherein a Venturi structure may increase downward airflow velocity.
The respirator of Embodiment 1, wherein the hood body may further comprise a shroud coupled to the hood body, the shroud may have a lower circumference edge, wherein the lower circumference edge may be disposed between the surgical gown and the user.
The respirator of Embodiment 1, wherein the conduit may be disposed between the shroud and the user, and wherein the conduit may direct user exhaust downward from the nose of the user.

### BRIEF DESCRIPTION OF THE DRAWINGS

FIG. 1: Some embodiments of a positive pressure respirator assembly with ear seal and acoustic region are shown.

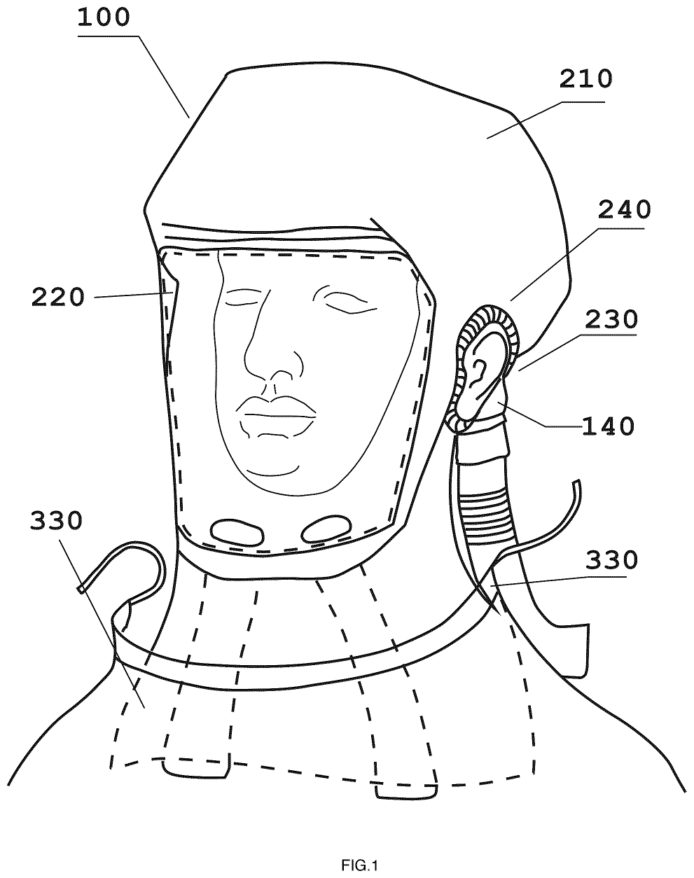

FIG. 2: Some embodiments of the positive pressure respirator assembly shown from the side view. A portion of a surgical gown is shown in the act of being added to the individual.

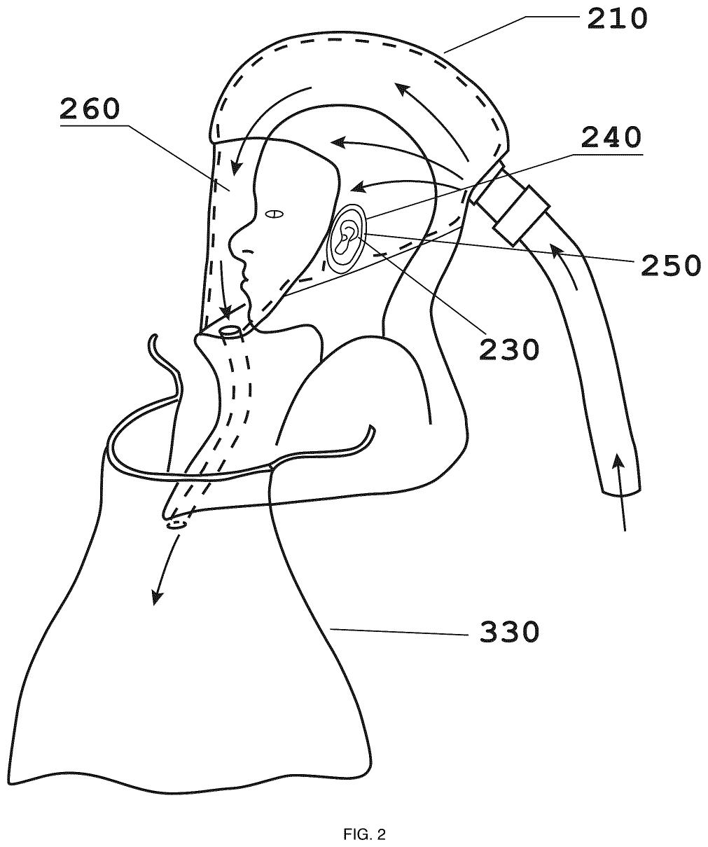

FIG. 3: Some embodiments of a positive pressure respirator assembly is shown, such as the one shown in FIG. 2, with the majority of side view of a surgical gown being shown, wherein the arrows that are pointed downwards depict the flow of air in the area between the surgical gown and the user's body. Downward airflow inside gown may be useful for source control.

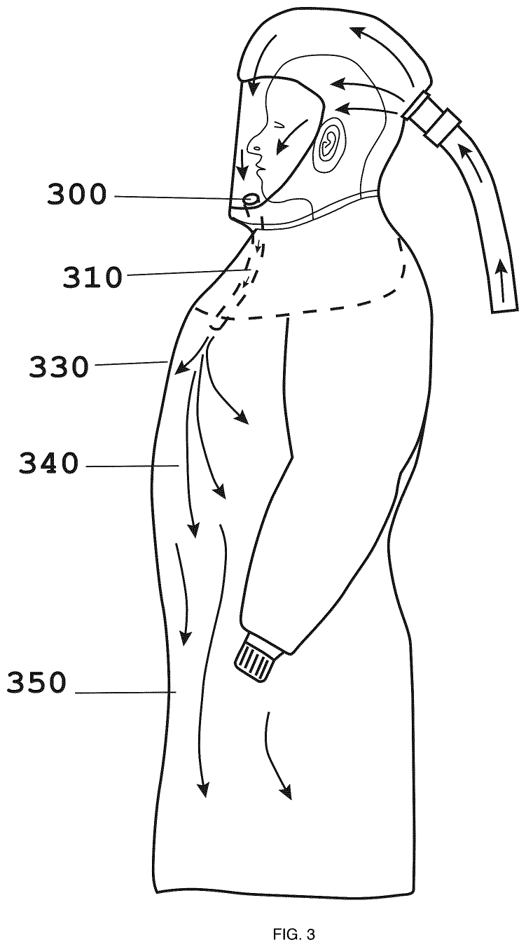

FIG. 4: A side view of the positive pressure respirator assembly is shown. Line 103-103 shows the line of a cross-sectional plane, which is shown in FIG. 5; line 105-105 shows the line of a cross-sectional plane, which is shown in FIG. 6.

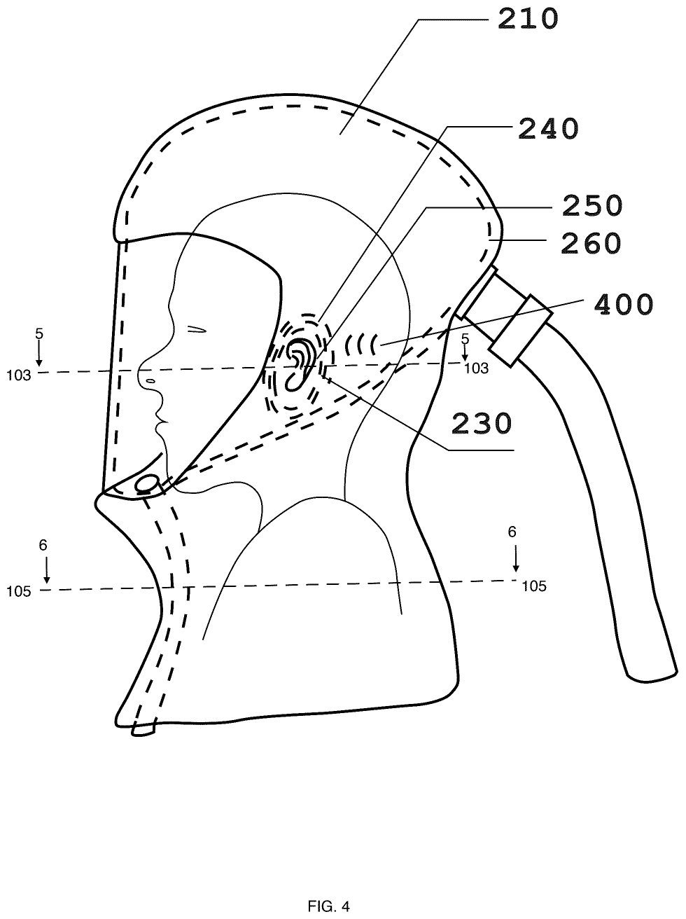

FIG. 5: A cross-sectional plane, which is an ear-region cross-section showing acoustic transmission, is shown; the cross-sectional plane is a transverse view at ear level. The hood of the positive pressure assembly adjacent to a user's ear is configured for acoustic transmission, which may be a communication pathway with maintained positive pressure.

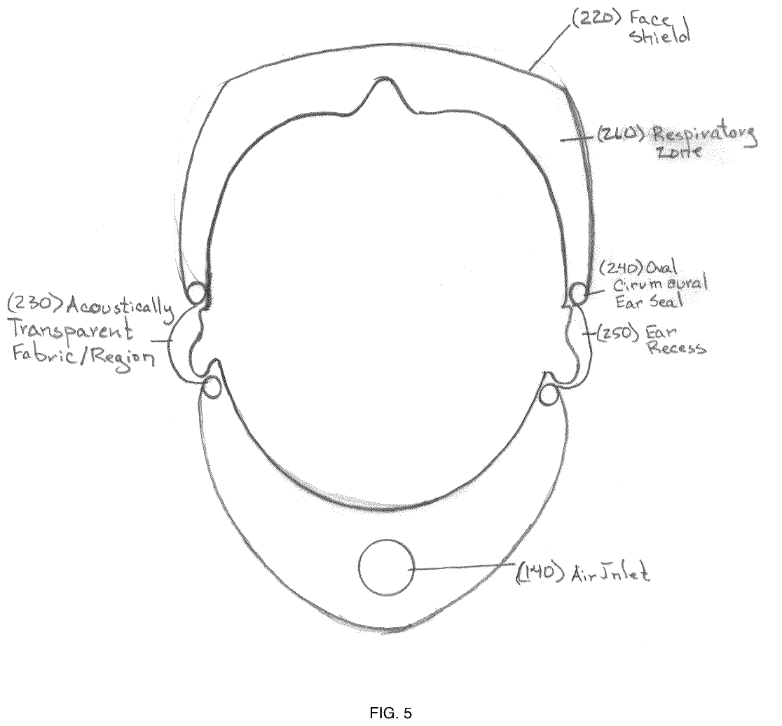

FIG. 6: A chest-level transverse plane view of the positive pressure respirator assembly is shown.

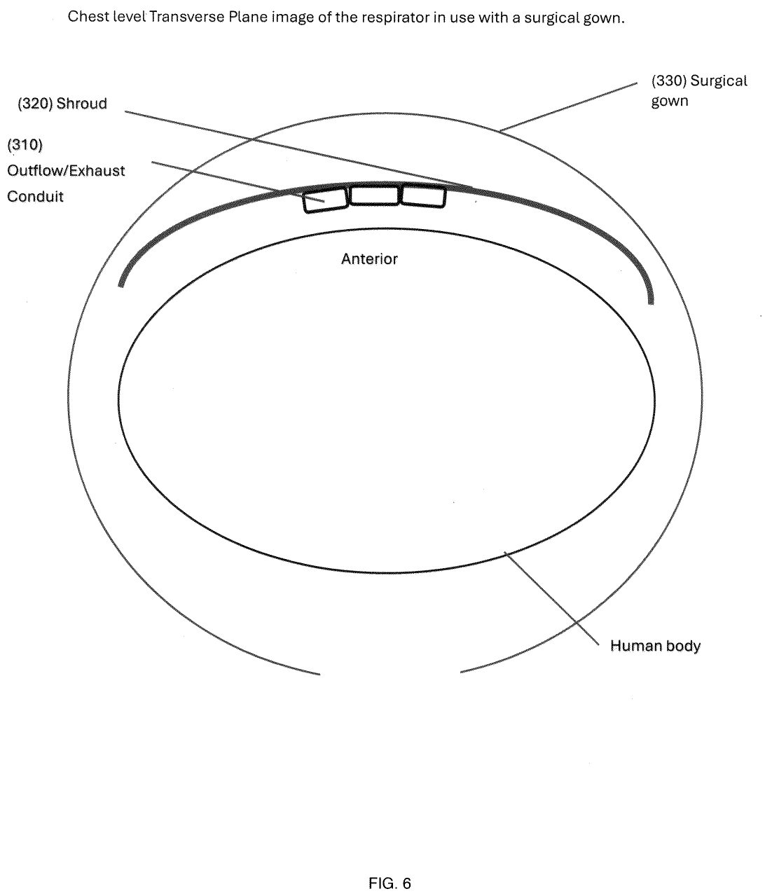

### DETAILED DESCRIPTION

It will be readily understood that the components of the present invention, as generally described with reference to the drawings herein, could be implemented in a wide variety of different configurations. Thus, the following more detailed description of the embodiments of the system and method of the present invention, is not intended to limit the scope of the invention, but is merely representative of various embodiments of the invention. Unless explicitly stated, the use of “or” means and/or, that is, this the non-exclusive meaning of or.

The surgical team's respiratory exhaust contributes to the frequency and severity of SSIs. If respiratory exhaust is redirected away from the surgical site and into the non-sterile side of the surgical gown, SSI rates may decrease. The disclosed positive pressure respirator assembly may contain a mechanism to intentionally control and redirect respiratory exhaust away from the surgical field.

In use, purified air enters the hood through air inlet (140) and pressurizes respiratory zone (260). The airflow then exits via exhaust conduit (310) into the non-sterile side of the surgical gown (330). The airflow continues downward (340), redirecting respiratory exhaust away from the surgical field.

The acoustically transparent region (230), sealed by circumaural ear seal (240), allows the wearer to hear speech while maintaining pressure boundaries. This may improve communication and may reduce fatigue.

A positive-pressure respirator hood (100) is disclosed, wherein in some preferred embodiments, positive-pressure respirator hood (100) is designed to direct respiratory exhaust downward into the interior (non-sterile side) of the surgical gown (330). The system maintains positive pressure in a respiratory zone (260) supplied by purified airflow via an air inlet (140). Instead of allowing overflow exhaust to escape uncontrolled, the hood incorporates an exhaust conduit (310) that terminates inside the gown at the chest region. The airflow then travels downward (340), away from the surgical field, improving source control and providing cooling to the wearer.

A positive pressure respirator assembly having a conduit directing exhaust towards the ground is disclosed. The positive pressure respirator assembly may have a conduit, such as tubing, that is disposed between a shroud and a user; in preferred embodiments, the bottom of shroud is disposed behind a surgical gown, and in some preferred embodiments, the conduit conducts user's exhaled air, also known as exhaust, in a downward direction.

Optional Exhaust Interface Components (which may be included individually, or in combination, as features of the disclosed positive pressure respirator assembly): a wide plume diffuser to distribute airflow across the torso; a removable condensation collection reservoir; an optional exhaust filter for infection control protocols; one or more valves to regulate airflow or prevent backflow; or, a Venturi structure to increase downward airflow velocity and transport moisture lower in the gown.

### REFERENCE NUMBERING SYSTEM

(100) Respirator Hood Assembly
(140) Air Inlet/Blower Hose Connection
(210) Hood Body
(220) Face Shield
(230) Acoustically Transparent Region
(240) Circumaural Ear Seal
(260) Respiratory Zone
(300) Exhaust Outlet
(310) Exhaust Conduit
(320) Shroud/Neck Drape
(330) Surgical Gown (Interior Non-Sterile Surface)
(340) Downward Exhaust/Cooling Airflow

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A positive pressure surgical respirator comprising a hood body, a face shield, an air inlet supplying purified airflow to a respiratory zone defined by the hood body and the face shield, and an exhaust conduit receiving user respiratory exhaust and directing the user respiratory exhaust into the interior side of a surgical gown.

2. The respirator of claim 1, wherein the airflow travels downward away from the surgical field.

3. The respirator of claim 1, further comprising an acoustically transparent region sealed by a circumaural ear seal.

4. The respirator of claim 1, further comprising a diffuser located at the exhaust conduit terminus.

5. The respirator of claim 1, further comprising a removable condensation collection reservoir.

6. The respirator of claim 1, wherein one or more valves regulate airflow or prevent backflow.

7. The respirator of claim 1, wherein a Venturi structure increases downward airflow velocity.

8. The respirator of claim 1, wherein the hood body further comprises a shroud coupled to the hood body, the shroud having a lower circumference edge,
wherein the lower circumference edge is disposed between the surgical gown and the user.

9. The respirator of claim 1, wherein the conduit is disposed between the shroud and the user, and wherein the conduit is directing user exhaust downward from the nose of the user.
